(19) United States
(12) Patent Application Publication
(10) Pub. No.: US 2015/0160741 A1
(43) Pub. Date: Jun. 11, 2015

(54) DEVICE ALLOWING TOOL-FREE INTERACTIVITY WITH A PROJECTED IMAGE

(71) Applicant: 3M INNOVATIVE PROPERTIES COMPANY, St. Paul, MN (US)

(72) Inventors: Ronald D. Jesme, Plymouth, MN (US); Nathaniel J. Sigrist, Bayport, MN (US); Craig R. Schardt, Woodbury, MN (US)

(21) Appl. No.: 14/407,025

(22) PCT Filed: Jun. 4, 2013
(86) PCT No.: PCT/US13/43971

§ 371 Date: Dec. 10, 2014

Related U.S. Application Data
(60) Provisional application No. 61/661,898, filed on Jun. 20, 2012.

(51) Int. Cl. G06F 3/03; G06F 3/01

(52) U.S. Cl. CPC G06F 3/0304; G06F 3/017

(57) ABSTRACT

Devices that provide for interaction with an image are disclosed. More specifically, devices that provide for tool-free interaction with a projected image are disclosed.

### FIELD

The present description relates to devices that provide for interaction with an image. More particularly, the present description relates to devices that provide for tool-free interaction with an image that is projected.

### BACKGROUND

A number of different projection systems are known in the art. More recently, systems have been created that allow a user to interact with projected images, such as the Xbox Kinect™ from Microsoft Corporation (Redmond, Wash.) and the Wii™ from Nintendo Co. Ltd. (Kyoto, Japan). However, some of these solutions have various drawbacks, including higher cost, the need for large computational power and power consumption, potential need for users to interact by means of a tool, and other means.

### SUMMARY

In one aspect the present description relates to a system for interacting with a projected image without a tool. The system includes an infrared light emitting source and a monolithic multi-functional sensor device. The infrared light emitting source projects an infrared beam toward a first target area. The multi-functional sensor device includes an image capture function and an image processing function. Further, the infrared light emitting source and multifunctional sensor device are configured such that when a user provides a gesture near the first target area, the existence and position of the gesture is detected by the multi-functional sensor device and processed. In at least one embodiment, the system may further include a first work surface upon or near which the first target area is positioned. The work surface absorbs, scatters, or reflects infrared light. In one embodiment, the work surface may be a countertop. The system may also include a projection device that projects an image onto the work surface. The existence and position of the gesture being processed may include altering the projected image.

In one embodiment, the system may also include a second infrared beam projected from the infrared light emitting source and a second target area towards which the second infrared beam is projected. The system may also include a third infrared beam projected from the infrared light emitting source and a third target area towards which the third infrared beam is projected. The working surface may also include non-target areas. The first target area, second target area and non-target areas may each include a plurality of sub-areas, where each sub-area is configured such that when a user provides a touch gesture on the work surface, the multi-functional sensor device determines which of the sub-areas were affected and computes a position of the touch gesture as the centroid of the affected sub-areas in order to determine whether to register a touch on a target or no touch.

In some embodiments, the system may include a camera lens that collects a portion of the infrared light from the first target area and focuses the light on the multi-functional sensor device. In some embodiments, the system may also include an emitter lens positioned between the infrared light emitting source and first target area, the emitter lens focusing the infrared light onto or near the first target.

The system may compute a series of heights associated with the touch gesture and determine that an intended press occurred if the following conditions are met: 1) a first height in the series of heights is above a first reference height, and 2) a second height in the series of heights occurring after the first height in the series is below a second reference height. The system may further determine that an intended click occurred if the further condition is met: 3) a third height in the series of heights occurring after the second height in the series is above the first reference height. In some embodiments, the difference between the first reference height and second reference highly is roughly between about 0.5 cm and about 2 cm.

The system may compute a series of heights associated with the gesture and determine that an intended lift occurred if the following conditions are met: 1) a first height in the series of heights is below the second reference height, and 2) a second height in the series of heights occurring after the first height in the series is above the first reference height.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification, reference is made to the appended drawings, where like reference numerals designate like elements, and wherein:

FIG. 1 is a diagram of a system according to the present description.

FIG. 2 is a diagram of a system according to the present description.

FIGS. 3a-3e illustrate sub-areas of target and non-target areas, as well as centroids of affected sub-areas.

FIGS. 4a-c illustrate diagrams providing how a touch is registered according to height.

FIG. 5 is a top-down view of a work surface with a projected image and target areas.

FIG. 6 is an oblique view of a work surface with a projected image and target areas.

### DETAILED DESCRIPTION

A number of systems have been created that allow a user to interact with projected images. However, many of these solutions have a number of drawbacks including higher cost, the need for large computational power and power consumption, and potential need for users to interact by means of a tool, such as a battery powered infrared emitter. Other drawbacks of some of the devices currently used are the requirement to use the device on a specially designed projection surface, or the need for placement of system components on or near the projection surface. The present description provides a solution that addresses each of these issues, by providing a simple tool-free interactivity system, for use with a projected image.

For some applications, it is especially desirable to provide a low cost, tool-free interactive solution that works on a wide range of surfaces, requires little computational power, consumes little power, is small in size, and does not require the solution to be mounted on or near the interactive surface. One application that could benefit from such a solution is an interactive projector that could be used in the kitchen, where the image is projected onto the countertop, and the user interacts with the content with bare hands. The user's hands and the countertop can be readily cleaned and sanitized without the need to clean a mouse, keyboard or other interactive tool. The projector and interactivity-enabling components can be mounted under a cabinet above the countertop in a location that does not obstruct working surfaces.

Typical interactivity solutions that might meet some of the performance criteria are too large, expensive and consuming of power to be practical solutions. For example, general sensing systems typically employ a complex structured lighting pattern (that in some cases is modulated over time with structures that are dynamically varied to best resolve the sensed structure), one or more high resolution cameras that include a high resolution sensing array and multi-optic lens, significant computational power of significant size (such as that of a PC) that is located some distance from the camera to ensure displacement from the sensing area. This computational power is interconnected with a digitizer connecting the camera to the computer. The “structured lighting” employed by such general sensing systems often utilize a high number of identical illumination dots or strips, which alone are not distinguishable from one another. Thus, additional computational power is needed to resolve the ambiguity introduced by their identical nature. The present description utilizes physical spatial configuration to avoid such ambiguity even if identical illumination shapes are used.

The present invention could also utilize illumination patches of distinct size and shape such that the system can easily distinguish them based on simple geometry. For example, one illumination patch could be a square and a second illumination patch could be a circle. In other embodiments, one illumination patch could be a solid circle, while the second illumination patch could be a circular ring of light with a void in the middle (a ring or doughnut shape). The illumination patches could be shaped as any appropriate shape either by the IR light source from which the light is emitted, or by optics manipulating the illuminated light before the emitted light reaches the target area. In addition, illumination patches could be distinguished by size. For example, a first illumination patch could be a first size, and a second illumination patch could be twice the size of the first illumination patch, or half of the size of the first illumination patch. In another embodiment, the detector may distinguish between illumination patches based on the distinct aspect ratios of the two spots. In other embodiments, the illumination patches may be elongated shapes such as ellipses or rectangles. Each elongated shape has a major axis (generally aligned with the widest direction of the shape). Illumination patches may be distinguished by the orientation of the major axis, even if the basic shape of the illumination patches is generally the same. As an example, two ellipses of the same general size may be distinguished based on the orientation of the major axis of the ellipses.

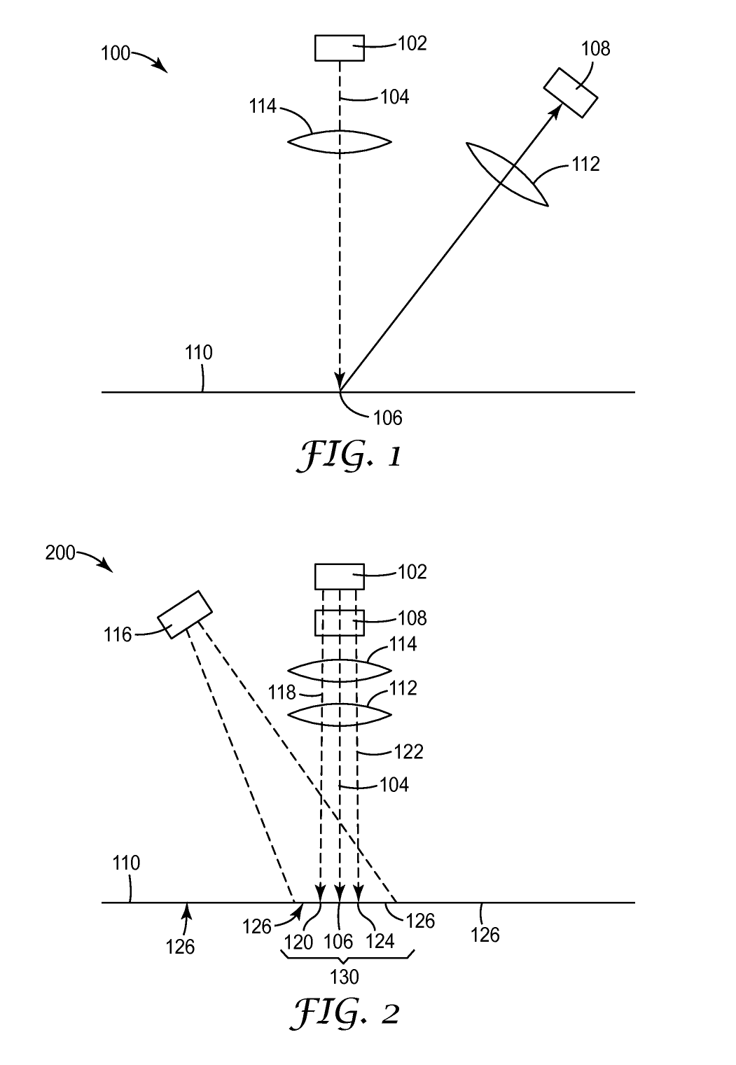

One embodiment of a system for interacting with a projected image without a tool, according to the present description, is illustrated in FIG. 1. System 100 includes an infrared light emitting source 102 that projects an infrared beam 104 towards a first target area 106. In some embodiments the infrared light emitting source may be a light emitting diode (LED), laser or incandescent filament. The system further includes a monolithic multi-functional sensor device 108. The multi-functional sensor device includes an image capture function and an image processing function. The infrared light emitting source 102 and multifunctional sensor device 108 are configured such that when a user provides a touch gesture near the first target area 106, the existence and position of the touch gesture is detected by the multi-functional sensor device and processed. As the multi-functional sensor device requires less processing power than other “structured lighting” systems, it may, at least in part, be made of up of a semiconductor chip (rather than, e.g., a CPU). The image capture function may be an infrared camera. In some embodiments, the infrared camera may use an optical filter to block the projected image from a sensing array of the device.

The multi-functional sensor device may be a monolithic (meaning on a single crystal) semiconductor device. Such a monolithic device includes both a sensing array to capture an image, and image processing electronics. The output of this device may include the Cartesian coordinates of the centroid of bright spots captured by the sensing array. The calculation of centroids results in coordinates that have sub-pixel resolution, thus adequate resolution can be obtained from a relatively low resolution sensing array. This relatively low resolution of the sensing array thus requires relatively little image processing because there are relatively few image pixels to process. This relatively small imaging array and relatively limited image processing requirement improves the viability for both of these functions to be realized in a monolithic silicon crystal. Solutions that implement separate sensing arrays (e.g. camera) and image processing circuits need to convey all of the pixel information from the camera to the image processing circuit, adversely affecting power, size and cost.

The system may also incorporate a simple microcontroller where the centroid data is subsequently evaluated to identify a touch.

The touch event may be one of several types of touch gestures that may result in distinct responses from the system. A touch event may be a single touch (for example a single press), a touch followed by a lift (for example, a click), a touch and hold for some period of time, multiple repeated touch and lifts to a single spot (for example, a double click), touching more than one spot simultaneously, or a touch which starts on one spot and then moves to an adjacent spot (for example, a swipe-type motion). In some situations, a touch gesture may be a contact entering the target area (for instance by sliding onto the target) and lifting off of the surface. This might be understood as an independent “lift” gesture. Other types of touches may also be detected per the requirements of the interactive system.

System 100 may also include a first work surface 110 that is positioned such that the first target area 106 is located upon or near it. The first work surface 110 may in at least one embodiment be a countertop. In some embodiments, work surface 110 may be absorbent of infrared light, such as that emitted from light source 102. Additionally, work surface 110 may scatter and/or reflect infrared light. It may be preferable for the work surface (or potentially a mat placed on the work surface) to provide improved brightness and contrast of a projected image (as noted below in system 200). The surface could also be used to improve the brightness and contrast of the IR spots.

System 100 may include a camera lens 112 that collects a portion of the infrared light from the first target area 106 and focuses the light on the multi-functional sensor device 108. The system may further include an emitter lens 114 that is positioned between the infrared light emitting source 102 and first target area 106. The emitter lens 114 serves to focus, direct, or shape the infrared light 104 onto or near the first target area 106. In other embodiments, e.g., where the light source is a laser, an emitter aperture 114 may be used rather than an emitter lens, to direct light onto the target area.

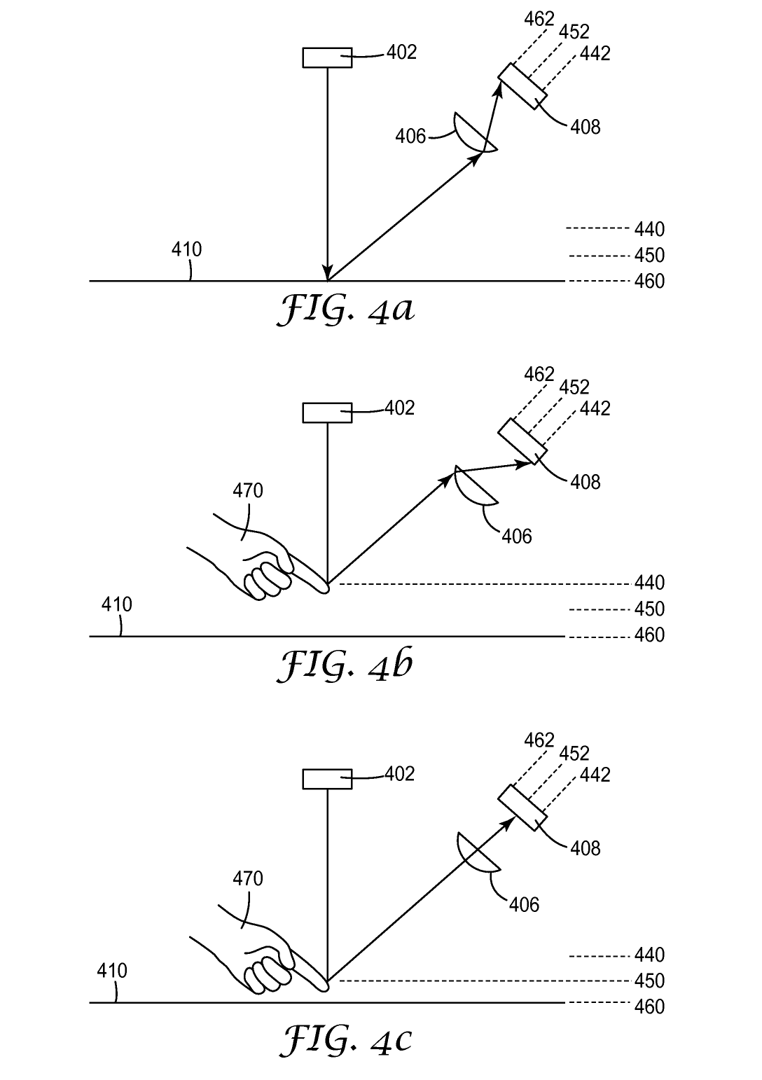

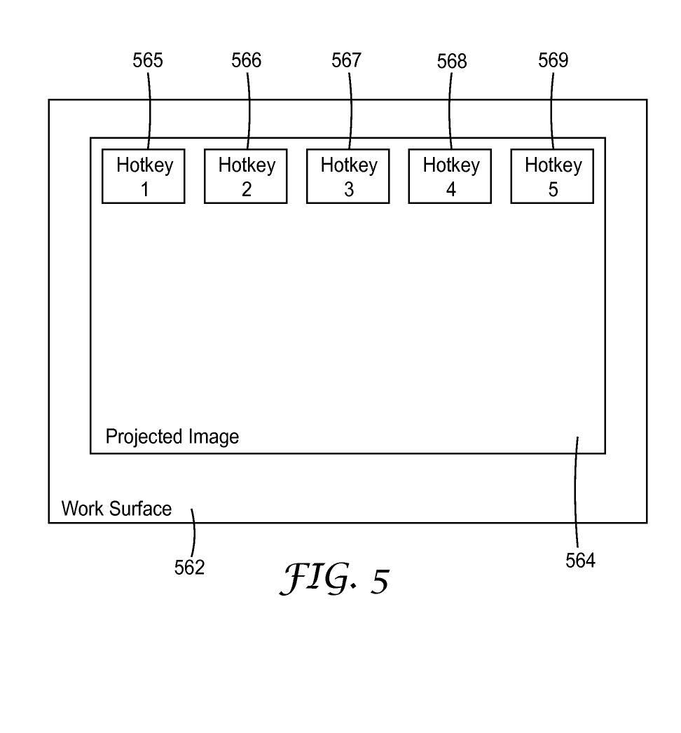

System 200 in FIG. 2 illustrates further potential embodiments of a system according to the present description. System 200 is illustrated rotated 90 degrees from the views of FIGS. 1, and 4a-4c, such that the multifunctional sensor device 108 and camera lens 112 are positioned on the opposite side of the light emitting source 102 from the viewer. System 200 also includes light emitting source 102, infrared beam 104, first target area 106, and multi-functional sensor device 108. Additionally, system 200 includes work surface 110, camera lens 112 that collects a portion of the infrared light from the first target area and focuses it on multi-functional sensor device, and emitter lens 114 that focuses infrared light onto or near the first target area 106. In this embodiment, system 200 also includes a projection device 116. The projector can comprise a spatial light modulator (e.g. a LCOS panel or an array of micro mirrors (e.g. Texas Instruments DLP)), LED, laser or incandescent illumination and a projection lens. The projection device may also be of the beam-scanning type such as the laser beam scanning projectors from Micro Vision, Inc. (Redmond, Wash.). The projection device 116 may project an image onto the first work surface 110, where the projected image has a width 130. In this system, the existence and position of the touch gesture being processed by the multifunctional sensor device 108 may include altering the projected image. In this and other embodiments, the system 200, and specifically the projector 116, light emitting source 102 and multi-functional sensor device 108 may each be mounted below a cabinet. Other element (e.g. lenses 114 and 112) may likewise be mounted below the cabinet.

Additionally, in some embodiments, the infrared light emitting source 102 may emit a second infrared beam 118 that is projected from the infrared light emitting source towards a second target area 120. Second target area 120 may be positioned proximate to first target area 106, such that it is also upon or near the first work surface 110. In some embodiments, the infrared light emitting source may additionally emit a third infrared beam 122. This infrared beam may be projected towards a third target area 124 that is also located near the first work surface 110 and first and second target areas. Working surface 110 need not be made up solely of target areas. Working surface 110 may also include areas that are non-target areas, i.e., are not areas onto which an infrared beam is projected. In the case where an IR absorbing work surface is used, a bright spot will not be detected because the IR beam 104 projected onto the surface 110 will be absorbed. However when the IR beam 104 is intercepted by a finger (or most other objects) the beam will be partially scattered and some of this scattered light will be collected by lens 112 and focused onto the sensing array 108. The height of the finger intercepting the array defines the location where the scattered light will fall onto the array 108.

In another embodiment, a non IR absorbing, IR scattering work surface 110 is used. In this embodiment, the IR spot will be imaged on the sensing array 108 even when the IR beam 104 is not intercepted by a finger or other object. In this case the location of the IR spot focused onto the sensing array 108 is representative of the location of the height of the work surface.

Although not shown as such in FIG. 2, emitter lens 114 may be a lens system. For example, lens 114 may be replaced by multiple lenses stacked along the axis along which light travels from the source 102 to the target 106. In other embodiments, multiple lenses may be provided, such that one or more lenses specifically address one IR beam (e.g. 118, 106 or 104), and the lenses lie on a common plane. The same may be true of camera lens 112 regarding the light that travels from proximate the target 106 to the sensor device 108.

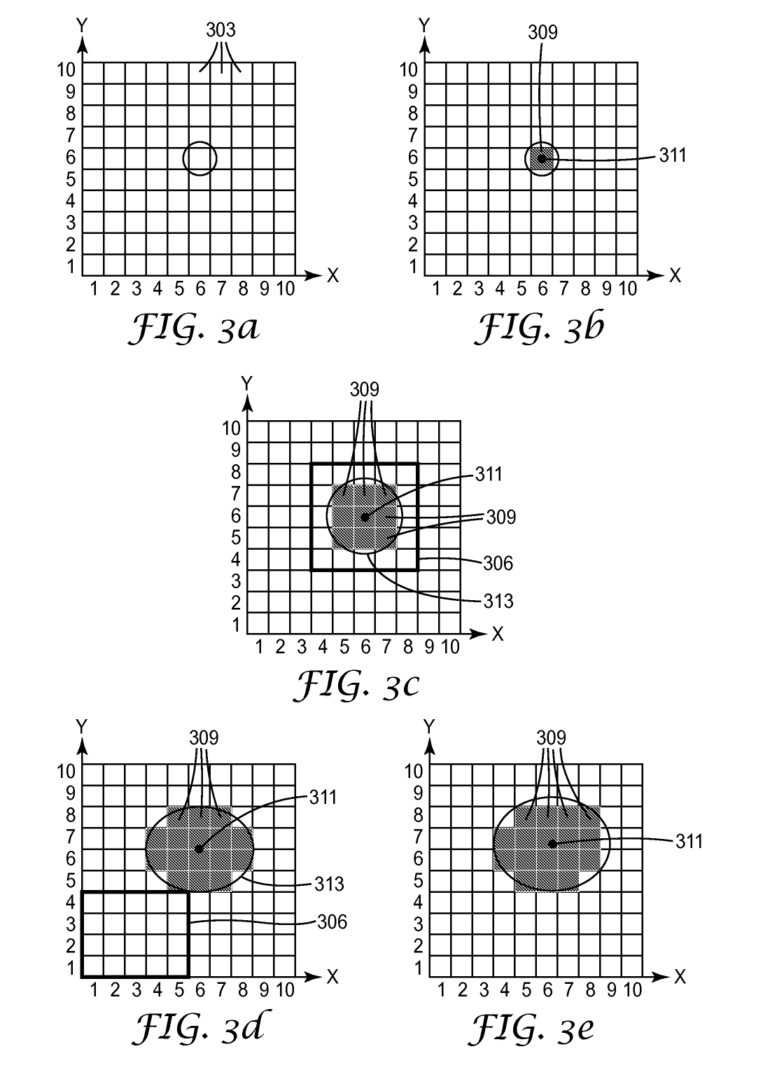

FIGS. 3a-3e illustrate a more detailed examination of how a touch gesture on one of the target areas is determined by the nature of the target areas. As illustrated in FIGS. 3a-3e, the working surface of a device (as viewed from above) may be made up of a number of sub-areas 303. Each sub-area 303 may be configured such that when a user provides a touch gesture on the work surface, the multi-functional sensor device determines which of the sub-areas were affected and, through an algorithm, computes a position of the touch gesture as the centroid 311 of the affected sub-areas 309 in order to determine whether to register a touch on a target or no touch. Specifically, in FIG. 3C, one can note a situation in which the boxed area 306 corresponds to the first target area. Here, assuredly a touch would be registered by the system. However, first target area 306 of FIG. 3d would not register a touch, as the centroid falls outside the area. Where over half of a sub-area is illuminated, the sub-area will be given a “value” of affected (depicted by regions 309) for purposes of calculating the centroid.

In one embodiment, the centroids 311 of the various spots can be found using the following equations:

X̅=ΣᵢⱼiLᵢⱼ/A_{T} Equation 1:

Y̅=ΣᵢⱼjLᵢⱼ/A_{T} Equation 2:

A_{T}=ΣᵢⱼLᵢⱼ Equation 3:

Where Lᵢⱼ is the logic value of 1 or 0 assigned to each pixel based on a threshold, and A_{T} is the number of affected sub-areas 309. For FIG. 3c, for example, having round spot 313, A_{T} is equal to 9, Σᵢⱼ is equal to 54, thus ( X̅, Y̅) is (54/9, 54/9) or (6,6) according to the numbering on the X and Y axes of FIG. 3c. FIG. 3d depicts a spot 313 that is oval. The spot may not be round due to optical aberration or other system configuration geometry etc. Equations 1, 2 and 3 can also be used to find the centroid of the spot in FIG. 3d: A_{T} is 16, Σᵢⱼ iLᵢⱼ is 96, and Σᵢⱼ jLᵢⱼ is 104, thus ( X̅, Y̅) is (96/16,104/16) or (6,6.5). This demonstrates that the centroid can be found with sub-pixel resolution.

To further demonstrate the ability to calculate centroids with sub-pixel resolution, FIG. 3e is examined: A_{T} is 17, Σᵢⱼ iLᵢⱼ is 104, and Σᵢⱼ jLᵢⱼ is 112, thus ( X̅, Y̅) is (104/17,112/17) or approximately (6.118,6.588), as rounded to the third decimal place. Thus small changes in the centroid position relative to the basic resolution of the sensing array can be sensed and calculated. This shows that a relatively small, low cost, sensing array can be used to deliver high precision centroid information, thus yielding precision height sensing information in a system. One of skill in the art will understand that a number of other appropriate position calculation algorithms may also be used and fall within the scope of the currently described invention.

FIGS. 4a-4c provide a more detailed illustration of how the system determines whether a touch at a target area has occurred. The infrared light emitting source 402 emits light towards work surface 410. The work surface or image surface may be understood as located at a height of zero, illustrated by element 460. Here where the IR light is not interfered with by a user, some of it is directed towards and imaged (possibly via a lens 406) at a first location 462 on the multi-functional sensor device 408. The multi-functional sensor device may include an array of sensors. In contrast, where a user 470 positions a finger at a greater height 440 from the surface 410, such that it also should not be registered as a touch, the light will be reflected and imaged onto a second location on the array of sensors 442 on multi-functional sensor device. Finally, where a user actually positions their finger directly on surface 410, the IR light from source 402 will intercept finger at height 450 and be reflected and imaged onto an third location 452 of sensor array. The third location 452 will generally be located between the first location 462 and second location 442 on the sensor array. The system will then properly be capable of determining that an intended touch has occurred at the target area. As noted earlier, this determination and processing may occur solely through the multi-functional sensor device, or through the multi-functional sensor device in conjunction with a simple microcontroller.

Of course, when a user “touches” the operative target area, the user's finger 470 will move through a series of heights. At first, the system will only register the lack of any interception by a user, thus it will measure the centroid of the illuminated spot at zero height 460. Next, as the finger enters the picture it will be measured at above a first reference height 440. It will then move downward such that it is located immediately below second reference height 450. This will indicate that a “press” touch event has occurred. After the “press” on the surface, the next height of the finger (in the series of height) may once again be above the first reference height 440. This will trigger that an intended “click” of the target area has occurred. As noted above, height 460 is simply height zero, that is, the height of the work surface and projection surface. Height 450 is chosen to be a bit above the maximum expected finger thickness of a user. Height 440 is generally chosen to be approximately 1 cm above height 450. This distance may, in some embodiments, be chosen in a range from 0.5 cm to 2 cm. If height 450 is too low, the top surface of the finger will be too high to enable a touch event to occur. If height 460 is too high, then taller object on the work surface 410 could trigger a transition through the height zone. Keeping height 460 relatively close in height to height 450 aids in preventing items on the work surface from interfering with the touch system by preventing tall objects from erroneously being interpreted as a touch transition through height 460. Similarly, this algorithm prevents short or thin objects placed on the work surface or counter top from erroneously being interpreted as a touch.

In some embodiments, the system may instead register simply a “lift” touch event, potentially when a finger is swiped or slid onto a target area and then lifted away from the surface. In such an embodiment, the multi-functional sensor device may determine that an intended lift occurred if a first height in the series of heights is below a second reference height (i.e. 450), and a second height in the series of heights that occurs after the first height in the series of heights is above a first reference height (i.e. 440).

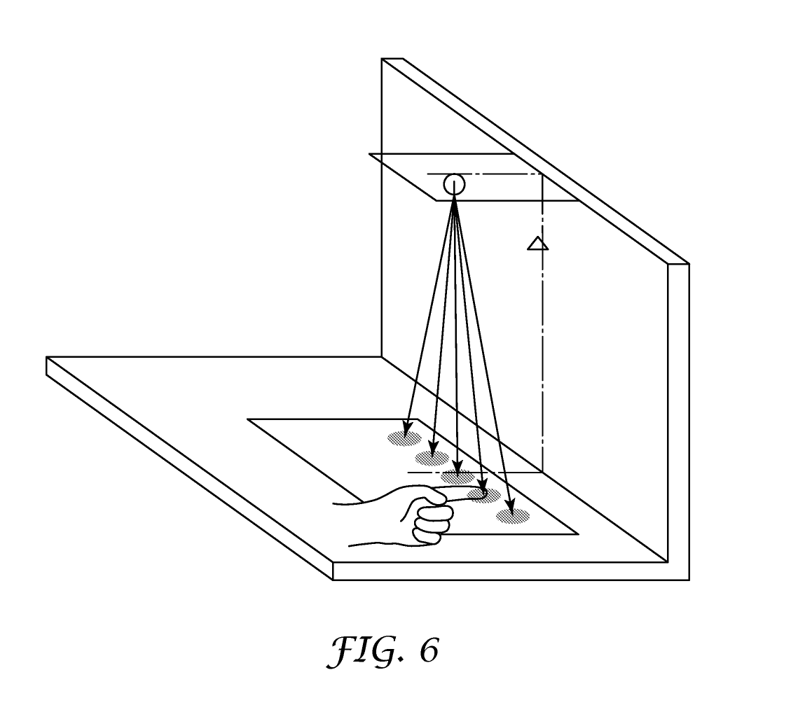

It should be noted that the array of sensors in the multi-functional device will not only extend in a first direction (e.g. the direction along which the height of a touch event may be considered), but also in a lateral direction, such that different target areas laterally spaced from one another may be sensed by the area. The layout of one such plurality of target areas is illustrated in FIGS. 5 and 6.

FIG. 5 provides a top-down view of a work surface that illustrates how a work surface could appear to a user. In this view, work surface is illustrated by element 562. On top of work surface 562, an image 564 may be projected. This image could include, e.g. a number of various recipes, steps to a recipe, decoration templates, an internet browser or electronic photo album. Within the projected image may be five (or any other number of) boxes 565, 566, 567, 568 and 569 that correspond to commands or prompts the user may like to enter by touch gestures. Corresponding to each box is a target area towards which an infrared beam of light is projected. When a user touches one of these boxes (whether by a press, click, double-click or slide/lift, etc.), the touch is registered by the multifunctional sensor device, and the projected image 564 and potentially the target areas may change in response. An oblique view of this is illustrated in FIG. 6 with system 600.

As noted above, the illumination patches sent from the IR light sources may be of different size and shapes and may in fact be distinguished from one another based on their respective sizes and shapes. In some embodiments, a change in shape of a given IR beam's illumination patch at the target area (as read by the sensor device) may indicate that a touch has occurred. For example, a sensor device may read that no touch is occurring when a circle of IR light is being reflected towards it (where, e.g., the work surface area is highly reflected), but indicate that a touch has occurred when a touch “blocks” an inner portion of the light, such that a ring shape, rather than a circle shape is registered by the sensor device.

The present invention should not be considered limited to the particular examples and embodiments described above, as such embodiments are described in detail to facilitate explanation of various aspects of the invention. Rather the present invention should be understood to cover all aspects of the invention, including various modifications, equivalent processes, and alternative devices falling within the spirit and scope of the invention as defined by the appended claims.

1. A system for interacting with a projected image without a tool, comprising:
an infrared light emitting source that projects an infrared beam towards a first target area;
a monolithic multi-functional sensor device, the multi-functional sensor device comprising an image capture function and an image processing function;
wherein the infrared light emitting source and multifunctional sensor device are configured such that when a user provides a gesture near the first target area, the existence and position of the gesture is detected by the multi-functional sensor device and processed.

2. The system of claim 1, further comprising a first work surface upon or near which the first target area is positioned.

3. The system of claim 2, further comprising a projection device, the projection device projecting an image onto the first work surface.

4. The system of claim 3, wherein the existence and position of the gesture being processed comprises altering the projected image.

5. The system of claim 2, wherein the first work surface is a countertop.

6. The system of claim 2, wherein the first work surface absorbs, reflects or scatters infrared light.

7. The system of claim 2, wherein the system is mounted beneath a cabinet.

8. The system of claim 2, further comprising a second infrared beam projected from the infrared light emitting source and a second target area towards which the second infrared beam is projected.

9. The system of claim 8, further comprising a third infrared beam projected from the infrared light emitting source and a third target area towards which the third infrared beam is projected.

10. The system of claim 8, wherein the work surface comprises non-target areas.

11. The system of claim 10, wherein first target area, second target area and non-target areas each comprise a plurality of sub-areas, each sub-area configured such that when a user provides a gesture on the work surface, the multi-functional sensor device determines which of the sub-areas were affected and computes a position of the gesture as the centroid of the affected sub-areas in order to determine whether to register a touch on a target or no touch.

12. The system of claim 8, wherein the first infrared beam is projected onto the first target area as a first shape illumination patch, and the second infrared beam is projected onto the second target area as a second shape illumination patch different than the first shape.

13. The system of claim 8, wherein the first infrared beam is projected onto the first target area as a first size illumination patch, and the second infrared beam is projected onto the second target area as a second size illumination patch, the second size being smaller or larger than the first size.

14. The system of claim 1, further comprising a camera lens that collects a portion of the infrared light from the first target area and focuses the light on the multi-functional sensor device.

15. The system of claim 1, further comprising an emitter lens positioned between the infrared light emitting source and first target area, the emitter lens focusing the infrared light onto or near the first target area.

16. The system of claim 1, wherein the system computes a series of heights associated with a touch gesture and determines that an intended press occurred if the following conditions are met:
1) a first height in the series of heights is above a first reference height, and
2) a second height in the series of heights occurring after the first height in the series is below a second reference height.

17. The system of claim 16, wherein the system further determines that an intended click occurred if the further condition is met:
3) a third height in the series of heights occurring after the second height in the series is above the first reference height.

18. The system of claim 16 wherein difference between the first reference height and second reference height is between about 0.5 cm and about 2 cm.

19. The system of claim 1, wherein the system computes a series of heights associated with a touch gesture and determines that an intended lift occurred if the following conditions are met:
1) a first height in the series of heights is below a second reference height,
2) a second height in the series of heights occurring after the first height in the series is above a first reference height.
